(19) United States
(12) Patent Application Publication
(10) Pub. No.: US 2018/0000101 A1
(43) Pub. Date: Jan. 4, 2018

(54) Biopreservation Composition Based on Facultative Heterofermentative Lactobacteria for Preventing and Controlling the Spoilage of Fresh and Cooked Meat Products

(71) Applicant: Química Rosmar, S.A. de C.V., Mexico City (MX)

(72) Inventors: Rodrigo Martínez Romero, Mexico City (MX); Rosa Margarita Romero Orozco, Mexico City (MX); Humberto Martínez Romero, Mexico City (MX); Sergio Rubén Trejo Estrada, Puebla (MX); Oxana Lazo Zamalloa, Puebla (MX)

(21) Appl. No.: 15/537,657

(22) PCT Filed: Dec. 18, 2015
(86) PCT No.: PCT/MX2015/050002

§ 371 Date: Jun. 19, 2017

(30) Foreign Application Priority Data
Dec. 19, 2014 (MX) MX/A/2014/015992

(51) Int. Cl. A23B 4/12; A23L 3/3463; A23B 4/22

(52) U.S. Cl. CPC A23B 4/12; A23B 4/22; A23L 3/3463

(57) ABSTRACT

The lactobacilli used in this invention are isolates that come from artisanal and fermented meats as well as material of plant origin from the central high plateau of Mexico. From a total of 60 strains of lactobacilli, 7 were selected due to their antagonistic capacity against pathogenic microorganisms and against spoilage microorganisms of raw and processed meat products. A method for preserving a food product, such as meat, whether raw or processed (stuffed products), was developed, including steps of inoculating of the meat with an effective amount of non-spoilage and non-pathogenic isolated bacteria in order to competitively inhibit the growth of unwanted pathogens and spoilage bacteria in meat products.

### FIELD OF THE INVENTION

The present invention relates to a composition of facultative heterofermentative lactobacteria, antagonist of pathogenic spoilage bacteria of cooked meat products.

### BACKGROUND OF THE INVENTION

Lactobacilli constitutes one of the main microbial groups traditionally used for meat products fermentation.

Lactic bacteria have been used in the manufacture of dry or semi-dry fermented stuffed products.

The species of bacteria recognized as fermentation guides in sausages and other stuffed products are L. sakei and L. curvatus. In USA the presence of pediococci and micrococci is more frequently recognized than that of lactobacilli.

The micrococcus genus is a genus present in starter cultures of meat fermentation for reasons of color and aroma stability. (Leroy de Devoist methods in biotechnology vol 18 Editorial Humana press).

However, many of the fermentation products of meat products do not have natural protection against pathogenic bacteria of a certain type, such as Listeria monocytogenes. In the particular case of the fermented products, we have sought the presence of starter bacteria which, in addition to having the ability to produce products with a pleasant flavor for the fermentation phase and maturity of the product, have the ability to produce bacteriocins that control or inhibit the proliferation of pathogens like listeria monocytogenes. Lactobacilli bacteriocins may be defined as small peptides or proteins having antibacterial activity against closely related strains. The bacteriocins produced by lactobacilli work very well under optimum laboratory conditions but not necessarily well under actual conditions of manufacture of stuffed products. The reason for this is the inactivation they suffer from proteases own of the meat or the present microbial consortium, or simply for the strain inability to produce bacteriocins under the fermented stuffed product application manufacturing system.

The production of fermented meats offers a specific condition for the development of strains oriented to their use as inoculants or primers. However, in Mexico most of the consumption of stuffed products in the form of ham, mortadella or sausages comes from the generation of a paste and subsequent cooking by immersion in water or steam systems. The thermal treatment in no case is developed with high pressure and temperature own of the autoclave system.

The cooling network associated with the cooked stuffed products distribution does not always work optimally. Likewise, beef, pork, poultry and even fish meat products have the same type of defects.

In fact, most of the meat products consumed in Mexico do not come from certified slaughterhouses considered TIF (Federal Inspection Type).

There is a high incidence of gastrointestinal diseases and deaths caused by these reasons in our country.

In the Mexican Republic, one of the most important health problems is constituted by gastrointestinal diseases, of which salmonellosis occupies a relevant place. In order to know how the chorizos contribute as vehicles for the transmission of this disease, sampling was carried out in markets and supermarkets in the Acapulco city, Guerrero.

Among the foods most commonly involved in causing salmonellosis are meat and processed products made from it. Meat is one of the basic foods in human feeding, the proteins it contains are of the highest quality for nutrition, but it has the peculiarity that it is very easily contaminated, which represents a risk for feeding. During the elapsing time since the slaughter until it is sold on the market, meat can contain hundreds of thousands or millions of microorganisms per gram; however, the most significant is the bacteria class and not their quantity; hence the importance of the care that must be taken in the preparation of the meat from its origin until its consumption. In general, meat that causes disease comes from infected animals, specifically calves and swine, but can be contaminated during storage or preparation.

Among the products that are made from meat are included stuffed products such as chorizo and longaniza, which are prepared with fresh meat of beef bovine or porcine and ingredients such as vinegar, garlic, paprika, pepper, oregano, cinnamon, anise, clove, cumin and other dressings; these products do not undergo processes of action and in certain factories they undergo to processes of drying once stuffed.

The gastroenteritis and diarrheal diseases occupy the second place of morbidity in the Guerrero State. These conditions are in many cases caused by the salmonella presence in food. To know the hygienic conditions of some of them, in a study a total of 336 samples of raw meats were analyzed, collected in nine localities of the entity to determine the presence of salmonella, using the standard methods. A total of 109 samples were contaminated with this pathogen, representing a 32.44 percent of positivity. The samples that presented the highest indices of salmonella were chorizo y longaniza, pork meat and cecina, being verified a somewhat deficient microbiological quality in these products.

To know the microbiological quality of foods, the Ministry of Health of the Guerrero State implemented, since 1985, health food surveillance programs, which were analyzed in the State Health Laboratory. Thus, the investigation of Salmonella sp in 336 samples of meat products was carried out; 89 samples of chorizos and longanizas were analyzed and a percentage of positivity of 57.3 was obtained for this pathogen, as can be seen in the following Table A (Grille M C, Saldate E O, Nicoli L M, “Incidence of Salomonella in meat products”; Salud Pública Mex, 1978; 20: 569-574).

TABLE A
Incidence of salmonella in raw meat and meat products

| | Samples | | |
|---|---|---|---|
| Product | Analyzed | Positive | Percentage |
| Longaniza | 1272 | 457 | 36.0 |
| Chorizo | 877 | 295 | 33.6 |
| Raw meat | 1762 | 488 | 27.6 |
| Moronga | 299 | 44 | 14.7 |
| Paté | 169 | 13 | 7.6 |
| Sirloin | 218 | 15 | 6.8 |
| Queso de Puerco | 660 | 43 | 6.5 |
| Sausage | 982 | 39 | 3.9 |
| Cold Meat | 395 | 15 | 3.7 |
| Ham | 1628 | 60 | 3.6 |
| Bacon | 247 | 11 | 4.4 |
| Other | 813 | 21 | 2.5 |

Derived from this background is that the search for inoculants was developed, which were not fermentation initiators but for use in cooked stuffed products of fresh meat of different origin; ham, sausage etc., which allow the control of proliferation of pathogenic bacteria that is important for the particular case of artisanal or industrial stuffed products produced in Mexico. Any strain to be used on an industrial scale for production of cooked meat must meet several conditions, namely:

1. That permits, by in vitro tests, the functionality in suitable culture media as an antagonist of bacteria or pathogenic consortia of spoilage cooked meat products.

2. That it is potentially cultivable in low-cost culture medium useful for industrial production at levels of bioreactors or fermenters.

3. That it colonizes and establish in the application systems i.e., in fresh or cooked meat products and has the ability to grow at high temperature and prevail at low temperature.

4. That when colonizing fresh or cooked meat products it is not a spoilage agent, that does not modify the color and texture, the flavor and aroma and that instead prevents the spoilage caused by pathogens.

Other characteristics of a preservative inoculant for fresh and cooked meats, works best when it is compatible with the presence or application in the use system of industrial application disinfectants or sanitizers that are used superficially in raw or cooked products. In addition, generally they should be bacteria that are not obligatorily homofermentative and that do not produce as a unique fermentation product the lactic acid which is a catabolite that generates an acidic spicy taste and that can typically modify the flavors of cooked products and can modify the color, flavor and aroma. Therefore, strains that are facultative heterofermentative should be sought and thus partially acidify the product. It must be reiterated that they do not modify the texture, taste or aspect of the meat food, nor the cooked or raw product.

For application in fresh or cooked meat products the inoculant must have the maximum capacity of exclusion or antagonism of pathogens or spoilage agents and the minimum faculty of modification. Some of the mechanisms by which lactic bacteria antagonize and in practice inhibit the growth of pathogenic or spoilage bacteria are:
Acid Production (lactic acid as the main product)
Hydrogen peroxide;
Bacteriocin;
Phage production.

Among the above presented characteristics, the most frequently attributed to strains with industrial application is the production of bacteriocins. Bacteriocins are small peptides or proteins non-susceptible of modification of common proteases that have antibiotic analogous activity but by mechanisms that do not contribute to generate toxicity in animal systems or human tissues. Antimicrobial spectrums of bacteriocins such as nisin (Hoover D., Nisina, Editorial University of Delaware), lactobiocin, lactocin and bavaricin are well documented and known. Some of these are produced by the producing strains in the application systems themselves, some others are produced only in the solid media of production or also submerged in culture broth. The directly application of a microorganism as a biopreservative or in contrast the application of the produced bacteriocin relays on several factors, i.e., the decision on the application of the bacteriocin either the living biological or the bacteriocin generated, but fundamentally it is associated to the cost of the function being sought and the application system. In meat products with spoilage biota as pathogen, is recommended the use of both fermentation products as peroxiácidos or bacteriocins as well as the biological themselves. The use of both offers possibilities of synergizing antimicrobial activity. (Monteville T., winkowski K., Chikindas M., Food Microbiology Fundamentals and Frontiers 2nd Edition, ASM Press Editorial Washington D.C. 2001)

Bacteriocins are grouped into biochemical types of amino acids, group 1 contains unusual amino acids as alanine, beta methyl anthyonine, group 2 are thermostable temperature stable proteins having a common glycine-glycine leader sequence. Both group 1 and group 2 bacteriocins have mixed activity against gram-negative and gram-positive bacteria (Drider D, Rebuffat S, The Prokariotes, Chapters 4, 5, 6, 7 and 8 Editorial Springer). The bacteriocins of groups 3 and 4 are very different from the preceding groups, are typically greater than 30 kda and are thermolabile, (Monteville T., Chikindas M., Food Microbiology Fundamentals and Frontiers (Biopreservation of foods) 3rd Edition, Editorial ASM Press Washington DC 2007. Chapter 34, Pages 747-765).

The use of non-acidifying starter cultures has demonstrated the reduction in viability and even the elimination of strains of Listeria monocytogenes in meat and dairy systems, the use of pediococcus and its bacteriocin pediocin synergistically has also generated greater safety in fermented foods. (H. Ghalfil,2, N. Benkerroum2, D. D. K. Doguiet1, M. Bensaid and P. Thonart Effectiveness of cell-adsorbed bacteriocin produced by Lactobacillus curvatus CWBI-B28 and selected essential oils to control Listeria monocytogenes in pork meat during cold storage).

Development of a new method for the detection of lactic acid bacteria capable of protecting ham against enterobacteriaceae (He'quet, V. Laffitte, E. Brocail, W. Aucher, Y. Cenatiempol J. Frere, C. Fremaux and J M Berjeaud, Development of a new method for the detection of lactic acid bacteria capable of protecting ham against Enterobacteriaceae, DANISCO INNOVATION, France, Editorial Letters in applied microbiology 2009).

Assay tests seems to be the safest way to approach to assess the potential of food-protecting crops. These methods, however, are time-consuming and often are difficult to implement. Here we describe the development of a sequential culture method, a new method for the screening of strains as protective cultures. Materials and Results: the sequential culture method is based on the stimulation, in a meat stimulation medium of the inhibition of enterobacteria by means of lactobacilli, previously observed in situ. The results obtained with this sequential culture method were harmonized with those of the assay test in sliced cooked ham and confirmed the antagonist potential of lactobacilli.

The results obtained from the screening of 187 lactic bacteria indicated that L. sakei, Lactococcus lactis diacetylactis and Carnobacterium spp were strong inhibitors of enterobacteriaceae, whereas Pediococcus spp, Leuconostoc spp and Weisselia spp and other species of lactobacilli and lactococci did not have the same inhibitory capacity.

Conclusions: the culture sequencing method seems to be a useful tool to quickly select cultures of lactobacilli which are good candidates for bioprotection of meat.

Significance and impact of the study: the culture sequencing method and the simulation medium could efficiently represent the experimental tests in the selection of a potential protective culture for all types of food, provided that have the appropriate means of stimulation corresponding to the food or for which the protective cultures were sought. (Letters in Applied Microbiology ISSN 0266-8254 668 Journal).

Antilisterial activity of a bacteriocin produced by Lactobacillus curvatus CWBI-B28 and Lactobacillus sakei CWBI-B1365 in raw beef and chicken meat.

The objective of the study was to evaluate the effect of the bacteriocins produced by L. sakei and L. curvatus on the growth and survival of Listeria monocytogenes in raw beef and chicken meat.

Methods and results: structural genes of sakacin P and sakacin G were identified in L. curvatus CWBI-B28 and L. sakei CWBI-B1365 using PCR amplification respectively. The effect of the two bacteriocinogenic strains either alone or in combination and the non-producing bacteriocin L. sakei strain LMG17302 in Lysteria monocytogenes was evaluated in beef and chicken meat. In beef meat, pathogenic bacteria were inhibited by bacteriocinogenic strains, however these strains had no activity in raw chicken meat when they were separately inoculated whereas they showed a clear anti-listeria effect when applied together.

Conclusion: The L. sakei producer of sakacin G and L. curvatus producer of sakacin P, can be applied in raw beef meat to inhibit L. monocytogenes. In chicken meat, inhibition of L. monocytogenes could only be achieved by the combined application of these bacteriocin-producing strains.

Significance and impact of the study: in some meat products, the combined application of lactic bacteria producing bacteriocin IIa may improve antilisterial activity.

Effect of lactic acid and lactic acid bacteria on growth of spoilage microorganisms of beef meat packed in vacuum.

Surface application of lactic acid and lactic bacteria in meat substrates was reported as a means of controlling spoilage populations.

The objective of this work was to determine the effect of the inoculation of lactobacilli and lactic acid in the development of spoilage bacteria in vacuum packed meat.

Finally, the sliced or cut meat was inoculated with Pseudomonas fluorescens, Brochothrix thermosphacta and Lactobacillus minor, then treated with an inoculum of BAL (Lactobacillus carnis, Lactobacillus pentosus and Staphylococcus carnosus) and lactic acid (200 mg/100 g of meat). The samples were vacuum packed and stored for 12 and 6 days at 4° C. and 20° C. respectively.

Ph and counts of aerobic bacteria, enterobacterial species, Pseudomonas spp., B. thermosphacta, and heterofermentative Lactobacilli were analyzed.

Lactic acid was the most efficient treatment to control spoilage populations. Lactobacilli should only be considered as an additional factor in parallel with other preservation methods to maintain spoilage populations in sufficiently low amounts as well as to extend the shelf life of the meat.

The effect sought in facultative heterofermentative bacteria of the type of lactic bacteria is the continuous production of various types of antimicrobial agents, such that the oxidizing power of hydrogen peroxide acts concurrently, the bacteriostatic effect of Lactic acid, and the membrane permeabilizing effect of bacteriocins described by Nes et al.

The processes and application systems that were generated from the invention described in U.S. Pat. No. 4,881,673 relate to a group of microorganisms, a lactobacillus, a bacterium of the Micrococcus genus, and a yeast (Debaryomyces). The cultures, mostly acidifying, have application in meat, in which the inoculation of the selected microorganisms produces acidified products of the type of pickled meat, or cured, stable with a longer shelf-life than those not treated.

Another invention, U.S. Pat. No. 5,576,035, protects the use of two bacteria, one of the Lactobacillus genus and another of the Hafnia genus, for the protection of fresh meat products by inoculation thereof. However, in such invention, the vast majority of applications relate to the use of bacteria for the protection of meat which are oriented to vacuum packaging.

U.S. Pat. No. 5,374,433 also directed to the protection of meat products, mostly fermented, uncooked or fresh, protects the use of homofermentative, obliged, lactic bacteria, producing lactic acid as the sole antimicrobial effector.

### SUMMARY OF THE INVENTION

In view of the disadvantages above described, the present invention aims to provide biopreservative compositions based on consortia of facultative heterofermentative lactobacteria which prevent and control the spoilage of both fresh products and cooked products.

Another object of the present invention is to provide biopreservative compositions based on consortia of facultative heterofermentative lactobacteria which can be successfully employed to prevent and/or control the spoilage of fresh or cooked products of both chicken and beef and pork.

It is a further object of the present invention to provide biopreservative compositions based on consortia of facultative heterofermentative lactobacteria in which the consortia proliferate at temperatures between 4° C. and 70° C.

It is also the object of the present invention to provide biopreservative compositions based on consortia of facultative heterofermentative lactobacteria which increase the shelf life of fresh or cooked products.

The foregoing objects and advantages of the invention will be apparent from the following detailed description thereof.

### DETAILED DESCRIPTION OF THE INVENTION

### Evaluation of Strains by Their Antimicrobial Activity In Vitro Evaluation of Antagonism vs Pathogens

Initially, microbial consortia were isolated from various sources of food processing plants in Mexico, resistant to operation conditions of pH, osmotic pressure, among other characteristics, mainly highlighting the presence of lactobacilli. All isolated bacterial consortia were tested for antagonism against the following strains of pathogenic bacteria:
Salmonella typhimurium
Samonella cholereae
Escherichia coli
Staphylococcus aureus
Listeria monocytogenes

The inhibition test was performed according to the modification described by Schilinger and Lucke, in which the inhibition halo is quantified as the magnitude of the radius of the halo, in mm.

The methodology for carrying out these tests was as follows:

Pre-inoculations of the pathogenic bacteria were performed which were incubated for 24 hours at 37° C. in the following manner.
One sample per tube with 5 mL of lactose broth to inoculate Salmonella typhi
One sample per tube with 5 mL of lactose broth to inoculate Salmonella cholerae
One sample per tube with 5 mL of lactose broth to inoculate Escherichia coli
One sample per tube with 5 mL trypticase soy broth to inoculate Staphylococcus aureus
One sample per tube with 5 mL of 1.5% yeast extract to inoculate Listeria monocytogenes

After the tubes were incubated for 24 hours, dilution adjustment was continued realized in the order of 10⁻⁸ with the Macfarland 5.0 standard.

Dilution was adjusted using sterile lactose broth.

Once the dilution of bacterial growth was standardized, each of the strains was sown with a sterile swab on plates with Müller Hinton agar massively.

After 15 minutes of massively sow each pathogenic bacterium, 0.8 cm high wells (sterile) were placed in the agar which were buried in the agar leaving a protruding portion to place on this the solution of the lactobacilli with inhibitory potential.

Bacteria that proved to be antagonistic to pathogens generated an inhibition halo in the corresponding pathogen as shown in Table 1.

TABLE 1
Presence of inhibition halo by bacterial antagonism

| Consortium | S. | | | | L. |
|---|---|---|---|---|---|
| Key | cholerae | S typhi | E. coli | S. aureus | monocytogenes |
| M17 | Yes | Yes | No | Yes | Yes |
| C35 | Yes | Yes | Yes | Yes | Yes |
| C352 | Yes | Yes | No | Yes | Yes |
| C261 | Yes | Yes | No | Yes | No |
| C262 | Yes | Yes | No | Yes | No |
| C14 | Yes | Yes | Yes | Yes | Yes |

Evaluation of antagonism vs. spoilage microorganisms (slime).

Antagonism tests were carried out on the selected consortia against a consortium of spoilage microorganisms that were isolated from samples of spoilage sausages. The inhibition test was performed according to the modification described by Schilinger and Lucke, in which the inhibition halo is quantified as the magnitude of the halo radius, in mm. The methodology for carrying out these tests was as follows:

Pre-inoculations of the spoilage bacteria were performed which were incubated for 72 hours at 37° C. in the following manner.

A sample of the spoilage microorganism preserved in glycerol was taken in a broth with 2% casein peptone and 1% meat extract.

Once the tubes are incubated for 72 hours, a dilution adjustment was carried out in the order of 10⁻⁸ with the Macfarland 5 standard. Dilution was adjusted using sterile lactose broth.

Once the dilution of bacterial growth was standardized, each of the strains was sown with a sterile swab on plates with Agar Standard Methods massively.

After 15 min of having massively sown each spoilage bacterium, 0.8 cm high wells (sterile) were placed in the agar which were buried in the agar leaving a protruding portion to place in it the solution of the potential inhibitor lactobacillus.

All bacteria were found to be antagonistic to spoilage microorganisms and generated an inhibition halo in the spoilage agent of each corresponding meat product.

### Identification of Selected Strains

### Microscopic Colonial Morphology

To carry out the identification of the strains selected for their antagonistic activity in vitro both spoilage and pathogenic microorganisms first, the morphology of the strains was verified to be confirmed that they were lactobacilli.

The strains were sown by cross-streaked repeatedly on

MRS agar selective of Lactobacillus growth, in which the form, color and size of the strains presumably lactobacilli were assessed.
Gram Staining

As part of the lactobacilli strain identification, their morphology was corroborated under the microscope and it was also determined whether they were gram-positive or gram-variable microorganisms.

The methodology for making the Gram stain used was as follows:

1. take the sample of microorganisms to be identified

2. make a swab on a coverslip

3. allow to dry at room temperature

4. fix the sample by means of flame (approx. 3 times)

5. add violet blue (violet crystal or gentian violet) and wait for 1 minute, rinse with water

6. add lugol and wait for 1 minute, rinse with water

7. add alcohol-ketone and wait for about 1 minute, rinse with water,

8. add safranin or basic fuchsin and wait 30 seconds.

Observe the microscope at 100× with immersion oil. Once the microbial identification was carried out, it was continued to perform:
Biochemical Tests

The Analytical Profile Index or (API) are fast methods that allow the identification of microorganisms through the performance of different biochemical tests. These systems consist of a plastic device with several microtubes containing different dehydrated culture media or different enzyme substrates according to the type of test that is required to assemble.

Each microtube of the system was inoculated with a suspension in 0.85% saline solution of a pure culture of the microorganism to be identified. In some cases, these microtubes were filled completely with the suspension, while in others the addition of sterile liquid paraffin was required, which provided the necessary anaerobic conditions.

### Taxonomic Identification (Sequence 16s)

It is started with a single source, either a single isolated colony, ethanol extract, DNA extract or an FTA elution card; of any of these samples; it is proceed to extract the genomic DNA from the isolated colony and by means of the use of PCR the first 500 base pairs of the 16S gene are amplified, a sequencing cycle was performed to label the fluorescent DNA and the sequence data were visualized in a automated sequencer, once this was done, the data were analyzed with a database and an Identification Report endorsed by the quality department was generated with a 98% accuracy and a 0.2% error rate. The identification of each strain of the consortia is shown in the following Table 2:

TABLE 2
Identification of consortia.

| Consortium | | |
|---|---|---|
| Key | Primary Identification | NRRL Key |
| M17 A | Lactobacillus paracasei tolerans | B-50831* |
| C35 | Lactonacillus curvatus | B-50826* |
| C352 | Lactobacillus sakei | B-50827* |
| C14 | Lactobacillus pentosus plantarum | B-50830* |
| C261 | Lactobacillus acidophillus | B-50828* |
| C262 | Lactobacillus allimentarius | B-50829* |
| M17G | Lactobacillus plantarum | B-50825* |

Deposit Information
*A deposit of each of the Lactobacillus sp genus consortia of this invention is maintained at the Agricultural Research Culture Collection (NRRL) International Depositary Authority 1815 N. University Street Peoria, Illinois 61604 U.S.A. Agricultural Research Culture Collection (NRRL), which has authorized the applicant to refer to the biological material deposited in the application, and has given its unrestricted and irrevocable consent for the deposited material to be made available to the public.

To satisfy the permissiveness requirements of 35 USC §112, and to certify that the deposit of the Lactobacillus sp genus consortia of the present invention meets the criteria set forth in 37 CFR §§1.801-1.809, the applicants hereby make the following statements regarding the bacterial consortia of the Lactobacillus sp genus deposited under the numbers NRRL B-50825, B-50826, B-50827, B-50828, B-50829, B-50830 and B-50831 (deposited on Mar. 18, 2013):

1. During the processing of this application, the Commissioner will be granted with access to the invention, upon request.

2. When the patent is granted, the bacterial consortium shall be available to the public under the conditions specified in 37 CFR 1.808.

3. The deposit will be kept in a public warehouse for a period of 30 years, or 5 years after the last request, or during the legal life of the patent, whichever is longer.

4. The viability of the biological material shall be tested at the time of the deposit; and 5. The deposit will be replaced if it becomes unavailable.

Access to this deposit will be available during the processing of this application, for persons determined by the Commissioner of Patents and Marks entitled to do so, pursuant to 37 CFR §1.14 and 35 USC §122. When granted any claim of this request, all restrictions on public availability of consortia will be irrevocably removed by providing access to a consortium deposit under the same Genus, in the Agricultural Research Culture Collection (NRRL) International Depositary Authority.

Unless defined otherwise, all technical and scientific terms herein have the same meanings as are commonly understood by those of ordinary skill in the art to which the present invention pertains. While any methods and materials, similar or equivalent to those described herein, may be used, in practice or in the tests of the present invention, preferred methods and materials are described herein. All cited publications, patents and patent publications are incorporated herein in their entirety, for all purposes, by reference.

The publications discussed here are provided solely for their description prior to the filing date of the present application. Nothing herein is to be construed as an admission that the present invention is not entitled to precede, on the date of such publication, by virtue of a prior invention.

While the invention is described with respect to specific embodiments thereof, it will be understood that it is susceptible of further modifications; and this application is intended to cover any variations, uses or adaptations of the invention which generally follow the principles of the invention and including those differentiations of the present disclosure which fall within the practice known or customary in the art to which the invention pertains, and may be applied to the essential aspects set forth above, and which follow the scope of the claims.

### Production of Microorganisms in Liquid Media

The isolated lactobacilli were cultured in culture media that allowed their development and proliferation. The content of the culture media is described below.

### Description of Culture Media

Suitable carbon sources include high purity sugars such as maltodextrins, sucrose, glucose, fructose, lactose, mannose and xylose among others. In addition, complex carbon sources such as; honey, juice, milk serum, sugar mills, vegetable extracts and vegetable hydrolysates.

Suitable nitrogen sources such as ammonium sources, nitrates, amino acids, yeast and meat extract, among others.

Mineral sources, micronutrients and macronutrients such as; phosphates, salts of magnesium, phosphorus, manganese, among others.

Natural sources of vitamins and cofactors.

These liquid culture media are produced in shake flasks or in static form, increasing their volume in fermentors or bioreactors.

When the lactobacilli grow, here the whole culture broth can be used or fractionated by separating the biomass by filtration. In such a way that the biomass or the supernatant that has demonstrated antimicrobial activity can be used, since this one is presumably rich in bacteriocins.

Evaluation of consortia for their antimicrobial activity in fresh and cooked meat
Antimicrobial Activity in Chickens

Dead poultry are bled, plucked and eviscerated and sanitized with water and a chlorine solution first.

Subsequently, the formulated product of the bacterial consortium M17 is added in a solution of a medium with some organic acid, which is preferably 1% acetic acid and to carry this out, the consortium is cultured as follows:

The M17 consortium is sown in a MRS broth; one sample in 10 mL and incubated 48 hrs. later this volume is sown in 100 mL 24 hrs at 30° C. and finally this volume is sown in a flask with 500 mL for 48 hrs.

Once the inoculum is had, it is used complete i.e., the grown cells plus the culture medium and 1% acetic acid is added.

The skinless chicken pieces are placed in a tray and the whole solution previous is added directly to the chicken as a marinade, 15 to 20 mL solution per piece of chicken (100 g).

Once the pieces are immersed in the tray, it is covered by an adherent plastic (without vacuum) and placed in refrigeration for sale in a supermarket.

Inoculation of the lactobacilli increases the shelf life of fresh chicken by 40% from the time it is packed in the tray.

This implies that if its shelf life in refrigeration at 4° C. is 7 days maximum considering that on the 7th day there are already odors of putrefaction, with the treatment of the M17 consortium, the useful life reaches the same conditions at least 11 days.

Interactions with Antimicrobial Chemicals Products

Survival tests were performed on the formulation of the M17 consortium to organic acids and chemical sanitizers using the following concentrations:
Acetic acid 2%
Acetic acid 1%
“Percirros” 300 ppm
“Perlactirros” 300 ppm

Organic acids and sanitizers are used regularly to reduce the microbial load so that spoilage microorganisms do not produce undesirable product characteristics and have a longer shelf life. For purposes of the present invention, 2% Acetic acid and 1% strength were used.

The M17 consortium was cultured in a culture broth for 48 hours at 30° C., starting with an initial inoculum of 10⁸ to 10⁹, after 48 hours the broth of the bacterial consortium was added to the fresh chicken, adding for each 100 grams of chicken, 20 mL of broth with the consortium and 1%, 2% of (the used lactobacillus solution) concentrated glacial acetic acid, for each 20 mL were added 0.4 mL and 0.2 mL of acetic acid respectively. The chicken pieces were placed in a tray with their immersion broth, the package was closed with the chicken resulting in that the 1% concentration of concentrated acetic acid gives a shelf life increased up to more than 50% with regarding the shelf life of the product without treatment; being days without treatment and at least 11 days with treatment with the consortium and acid.
Antimicrobial Activity in Sausages

Antagonism tests were carried out on selected consortia C35 and M17 against a consortium of spoilage microorganisms that were isolated from samples of spoilage sausages from different trademarks.
Removal of Spoilage Material

To generate the spoilage in the sausages, a concentrate of spoilage strains material was prepared as follows:

Commercial sausage samples (4) were incubated at 35 and 45° C. for 48 hours to encourage growth of spoilage microorganisms.

Once the samples were incubated, they were extracted with a minimum proportion of sterile water, i.e., a 9:1 ratio of sausage with water.

The extraction was performed in two ways:
By a stomacher type process
Extraction of surface spoilage

The concentrated liquid obtained was stored in a 1:1 solution of 70% glycerol to preserve the spoilage cellular material.

The material in glycerol was stored in eppendorf tubes at −20° C.

To reproduce the growth of spoilage bacteria the following procedure was performed:
A sample of the glycerol material was taken in sterile tubes with 1% meat extract.
The tubes were incubated at 35° C. for 72 hours
Dilutions of 10⁻¹ to 10⁻³ of all incubation times handled were handled.

Once bacterial growth is generated in the tube; observed by turbidity, was carried out the process of spoilage in the elaborated sausages.

Samples of sausages, prepared in a pilot plant, were placed in sterile flasks and its was inoculated with 100 microliters of dilutions in the order of 10⁻¹ and 10⁻³ of the generated material.

The flasks were incubated at 35° C., room temperature (25° C.) and in refrigeration to −4° C.

The spoilage of the elaborated sausages was manifested by the production of white film on the surface after inoculating the spoilage microorganisms.

On the other hand, sausages were inoculated with the selected bacterial consortia C35 and M17 (300 microliters) and the material was allowed absorb and then the spoilage consortium (300 microliters) was inoculated and left at refrigeration temperature and 30° C. To assess the protection of the formulations of consortia C35 and M17 in spoilage.

The test showed a protection in the sausage of the manifestation of “slime” or white film on the surface due to the antagonism created by the formulation of the previously inoculated C35 and M17 consortia.
Antimicrobial Activity in Ham

### Isolation of Consortia of Spoilage Microorganisms of Ham

Ham was used in a new closed package and allowed to incubate at 30° C. for 4 days. After 4 days, a white exudate was recovered in the ham package.

This exudate was preserved in cryoprotectant (70% glycerol) keeping it in eppendorf tubes in a 1:1 ratio (exudate+glycerol) at temperature of −70° C.

Later this consortium was used to be inoculated in slices of FUD® ham to reproduce the spoilage (exudate).

On the other hand, slices of ham were individually placed and allowed to incubate at 35° C. for 48 hours.

After that time, the spoilage ham was plated and individual colonies were isolated from the petri dish.

Two morphotypes were isolated mainly: a small white colony and a large orange colony.

Both colonies were purified and cryopreserved at −70° C. for subsequent inoculation into slices of ham. The spoilage derived from the small white colony was smaller in the ham being hardly perceptible.

The spoilage derived from the orange colony was more noticeable since to be inoculated in the ham after about 48 hrs it was possible to observe a spoilage in the color of the slice (discoloring) and also, a proteolytic spoilage in the slice resulting in a visual effect of get fall apart by softening the tissue.

Another experiment was carried out by taking one of the slices placed in incubation to generate accelerated spoilage in the experiment, which presented greenish tones, this same was plated and the resulting consortium was again preserved in glycerol at −70° C.

Once the three different consortia were generated, the tests of antagonism in the ham were continued.

The tests of antagonism consisted in inoculating the ham sliced with the spoilage microorganisms isolated.

On the other hand, the slices of ham were inoculated with the formulation of the selected bacterial consortia C262 and C14 and the material was allowed absorb and then the spoilage consortium was inoculated and left at refrigeration temperature and 30° C. To assess the protection of the lactobacillus in the spoilage.

The test showed a protection in the slices of ham from the manifestation of “slime” or white film on the surface, or from the green stains on surface, or from the tissue degradation, due to the antagonism created by the formulations of the C262 and C14 consortia previously inoculated. Application of the formulation of the M17 Bacterial Consortium.

Dead poultry are bled, plucked and eviscerated and sanitized with water and a chlorine solution first.

Once this occurs the formulated consortium is added in a solution of a medium with an organic acid, preferably 1% acetic acid as part of the formulation and to carry this out is cultivated as follows:

The M17 consortium is sown in a MRS broth; one sample in 10 mL and incubated 48 hrs., this volume is then sown in 100 mL for 24 hrs. at 30° C. and finally this volume is sown into a 500 mL flask for 48 hrs.

Once the inoculum is had, it is used complete i.e., the grown cells plus the culture medium, and 1% acetic acid is added.

The pieces of chicken without skin are placed in a tray and the whole previous solution is added directly to the chicken as a marinade, 15 to 20 mL of solution per piece of chicken (100 g).

Once the pieces are immersed in the tray, it is covered by an adherent plastic (without vacuum) and placed in refrigeration for sale in a supermarket.

Inoculation of the formulation of the M17 consortium increases the shelf life of the fresh chicken by 40% from the time it is packed in the tray.

This implies that if its shelf life in refrigeration at 4° C. is 7 days maximum considering that on the 7th day there are already odors to putrefaction, with the treatment of the lactobacilli their useful life arrives in the same conditions at least to 11 days.

### Application of the Formulation of the C35 and M17 Bacterial Consortiums:

The pork meat (2 kg) is chopped and ground in a digester until a paste is obtained. The paste is mixed with a 0.08% nitrate solution, 1.5 g sugar, 20 g of cured salts, 5 g of polyphosphates, 15 g of sausage seasoning, 0.4 g of pink coloring, 0.25 g of nutmeg and 0.25 g of pepper and ice.

Once it is mixed with all these ingredients, it is ground again and the paste is placed in a stuffer where it is later placed in a cellulose casing which it adjusts to the size of the desired sausage.

When all the meat has been stuffed, it is cooked for 30 min at 65° C., immediately after a heat shock in water at 4° C. is given.

The sausages are then peeled from the cellulose casing to be treated with the formulation of the bacterial consortia C35 and M17, which are prepared as follows:

Consortia C35 and M17, are sown in a Molasses broth, one sample in 10 mL and incubated 48 hrs., this volume is then sown in 100 mL 24 hrs at 30° C. and finally this volume is sown in a 500 mL flask for 48 hrs.

Once the inoculum is had, this is used complete i.e., the cells grown plus the culture medium.

The sausages are placed in a kettle containing the broth, where they will remain in a dipping that covers the whole surface, the culture medium will give them a touch of smoke in the initial coloring, serving as an indicator to determine that the whole surface of the sausage has been covered by the crop.

Once the immersion is carried out they are packed in a vacuum and stored at 4° C.

The product increases its shelf life by 30%, i.e., if the sausages normally last 4 weeks in their sealed packaging, with the treatment they increase to 6 weeks in refrigeration and the sealed packaging.

Application of the Formulation of the C262 and C14 Bacterial Consortiums.

Pork meat is only cut into pieces and seasoning for ham is added, 0.08% nitrate solution, 1.5 g sugar, 20 g of cured salts, 5 g of polyphosphates, 0.25 g of nutmeg and 0.25 g of pepper.

The meat with this mixture is kneaded for 3 to 4 hours until the softening of the tissue and therefore the incorporation of the ingredients into the meat.

Subsequently this mixture is placed in stainless steel molds of 50×35 cm which are closed and are baked at 100° C. for 2 hours for the cooking take place.

Once the molds leave the baked, should be allowed to cool for about 12 hours.

Once the material is cold, it is sliced into equal slices and each slice is sprinkled with a solution of the bacterial consortia C262 and C14, supplementing with M17 which is cultivated as follows:

The bacterial consortia C262, C14 and M17 are sown in an MRS broth; one sample in 10 mL and incubated 48 hrs., this volume is then sown in 100 mL 24 hrs. at 30° C. and finally this volume is sown in a 500 mL flask for 48 hrs. in which it has approximately a viable cell count of 2×10⁸ CFU/mL.

This solution is sprinkled on the slices of ham using a volume of approximately 5 mL per slice.

Subsequently this is packed and vacuum sealed and stored at 4° C.

Shelf life of the product is increased by 25%, if the product has a shelf life of 6 weeks is increased for up to 8 weeks.

1. A biopreservative composition based on consortia of facultative heterofermentative lactobacteria, comprising at least one of the non-spoilage and non-pathogenic lactobacteria of the genus Lactobacillus generating bacteriocins, organic acids and oxidants, to prevent and control the spoilage of fresh meat products and/or cooked meat products.

2. The composition according to claim 1, wherein the non-spoilage and non-pathogenic lactobacteria consortia of the genus Lactobacillus are selected from the group of isolated consortia and deposited in the NRRL under the following registration numbers B-50825, B-50826, B-50827, B-50828, B-50829, B-50830, and B-50831.

3. The composition according to claim 1, wherein the consortium B-50831 alone or formulated is used to prevent and control spoilage of fresh chicken.

4. The composition according to claim 1, wherein the consortium B-50826 and the consortium B-50831, either alone or formulated, are used to prevent and control the spoilage of cooked sausages.

5. The composition according to claim 1, wherein the consortium B-50829 and the consortium B-50830 are used, either alone or formulated, to prevent and control the spoilage of sliced ham.

6. The composition according to claim 4, wherein the predominant consortium is B-50831.

7. The composition according to claim 5, wherein the predominant consortium is B-50831.

8. The composition according to claim 1, comprising 1% concentrated acetic acid to prevent and control spoilage of fresh meat products and/or cooked meat products.

9. The composition according to claim 1, wherein the facultative heterofermentative lactobacterial consortia are capable of proliferating at temperatures in the range of 4° C. to 70° C.

10. The composition according to claim 2, wherein the facultative heterofermentative lactobacterial consortia are capable of proliferating at temperatures in the range of 4° C. to 70° C.

11. The composition according to claim 3, wherein the facultative heterofermentative lactobacterial consortia are capable of proliferating at temperatures in the range of 4° C. to 70° C.

12. The composition according to claim 4, wherein the facultative heterofermentative lactobacterial consortia are capable of proliferating at temperatures in the range of 4° C. to 70° C.

13. The composition according to claim 5, wherein the facultative heterofermentative lactobacterial consortia are capable of proliferating at temperatures in the range of 4° C. to 70° C.

14. The composition according to claim 6, wherein the facultative heterofermentative lactobacterial consortia are capable of proliferating at temperatures in the range of 4° C. to 70° C.

15. The composition according to claim 7, wherein the facultative heterofermentative lactobacterial consortia are capable of proliferating at temperatures in the range of 4° C. to 70° C.

16. The composition according to claim 8, wherein the facultative heterofermentative lactobacterial consortia are capable of proliferating at temperatures in the range of 4° C. to 70° C.
